(19) United States
(12) Patent Application Publication
(10) Pub. No.: US 2026/0251853 A1
(43) Pub. Date: Aug. 27, 2026

(54) FIBER POSITIONING APPARATUS UTILIZING VACUUM-ASSISTED RETENTION

(71) Applicant: Hyperlume Inc., Ottawa (CA)

(72) Inventors: Mohsen Asad, Ottawa (CA); Hossein Fariborzi, Auburndale, MA (US); Rasanpreet Singh KHANGURA, Ottawa (CA)

(73) Assignee: Hyperlume Inc., Ottawa (CA)

(21) Appl. No.: 19/065,939

(22) Filed: Feb. 27, 2025

(51) Int. Cl. G02B 6/36

(52) U.S. Cl. CPC G02B 6/362; G02B 6/3636

(57) ABSTRACT

The present disclosure discloses a fiber positioning apparatus comprising an enclosure having an internal chamber and an engagement recess extending along a portion of the internal chamber. An attachment interface is positioned on an outer surface of the enclosure. A flexible retention sheet (FRS) extends through the internal chamber, the FRS comprises a protruded section extending into the engagement recess and a plurality of perforation holes extending therethrough. The FRS provides an interface to receive at least one fiber component. A suction conduit is fluidically coupled to the engagement recess and extends along a portion of the enclosure. The suction conduit establishes fluid communication with each perforation hole. The suction conduit is connected to a vacuum source to induce a negative pressure within the FRS. The induced negative pressure causes attachment of each received fiber component to the FRS till the induced negative pressure exists.

### TECHNICAL FIELD

The present disclosure generally relates to fiber positioning systems. Further, the present disclosure particularly relates to a fiber positioning apparatus utilizing vacuum-assisted retention.

### BACKGROUND

Generally, holding and positioning optical fibers in proximity is essential for various applications, including high-density fiber packaging, optical interconnects, and experimental crosstalk characterization. Maintaining fiber alignment with minimal spacing enables optical performance and enabling experimental analysis. Various fiber holding techniques, including fiber grippers, metallic vacuum stages, and V-groove arrays, are employed for fiber positioning. However, each of the mentioned techniques is associated with structural, mechanical, and operational limitations that hinder precise fiber alignment, reconfigurability, and stress minimization.

These fiber grippers employ mechanical gripping elements to hold fibers at multiple contact points. Such gripping mechanisms exert pressure on fibers, leading to localized stress that may introduce micro-bending or optical loss. Additionally, fiber grippers require physical clearance around each fiber to accommodate gripping elements, thereby restricting the minimum possible fiber spacing. The inability to position fibers at extremely small pitches limits the feasibility of using fiber grippers in high-density fiber arrangements. Furthermore, fiber grippers necessitate manual or motorized adjustments for repositioning fibers, increasing the complexity of alignment procedures and making them unsuitable for rapid reconfiguration in experimental setups.

Moreover, metallic vacuum stages utilize vacuum suction to secure optical fibers on a flat holding surface. Such vacuum-based retention techniques are limited by the circular cross-section of optical fibers, which leads to vacuum leakage along the fiber periphery. To compensate for such leakage, higher vacuum pressure is required to maintain stable fiber retention. Increased vacuum pressure results in non-uniform forces being applied along the fiber length, introducing localized stress points that may alter fiber geometry and optical characteristics. Moreover, metallic vacuum stages typically feature rigid, flat surfaces, making them unsuitable for accommodating fibers of varying diameters or non-planar configurations. The inability to adapt to different fiber arrangements restricts the use of metallic vacuum stages in reconfigurable optical experiments or fiber bundle optimization studies.

Additionally, v-groove arrays provide predefined grooves for aligning fibers in a fixed configuration. Such alignment structures rely on epoxy bonding to secure fibers in position, preventing fiber movement once placement is completed. The requirement for epoxy bonding makes V-groove arrays irreversible, eliminating the possibility of repositioning or reusing fibers. Experimental procedures that require iterative adjustments to fiber placement, such as optimization of fiber-to-fiber spacing for crosstalk measurement, cannot be effectively conducted using V-groove arrays. Additionally, V-groove arrays impose constraints on the minimum fiber spacing, as groove widths are predefined, making them unsuitable for configurations requiring variable fiber arrangements.

Difficulties arise in achieving controlled fiber alignment at extremely small pitches of 50, 70, or 80 μm, particularly in experimental studies focused on measuring crosstalk between adjacent fibers. Fiber grippers impose a lower bound on fiber spacing due to the physical constraints of gripping elements. Metallic vacuum stages introduce stress-related optical distortions, affecting signal integrity and measurement accuracy. V-groove arrays, while maintaining fixed alignment, do not allow iterative repositioning, making them unsuitable for studies requiring dynamic configuration adjustments. Experimental setups that necessitate multiple alignment iterations, such as optical fiber bundle optimization or modular interconnect testing, require a reconfigurable fiber positioning solution that minimizes fiber stress while maintaining stable retention.

In light of the above discussion, there exists an urgent need for solutions that overcome the problems associated with conventional systems and/or techniques for positioning and securing optical fibers.

### SUMMARY

The present disclosure provides a fiber positioning apparatus comprising an enclosure having an internal chamber and an engagement recess extending along a portion of the internal chamber. An attachment interface is positioned on an outer surface of the enclosure. A flexible retention sheet extends through the internal chamber and comprises a protruded section extending into the engagement recess. The flexible retention sheet further comprises a plurality of perforation holes extending through the flexible retention sheet to provide an interface for receiving at least one fiber component. A suction conduit is fluidically coupled to the engagement recess and extends along a portion of the enclosure. The suction conduit establishes fluid communication with each perforation hole and is connected to a vacuum source to induce negative pressure within the flexible retention sheet. The induced negative pressure causes attachment of each received fiber component to the flexible retention sheet if the negative pressure is maintained, thereby enabling vacuum-assisted fiber positioning.

Further, the attachment interface is secured to a support structure through a fastening assembly positioned along the attachment interface. Said fastening assembly stabilizes the enclosure while maintaining alignment of the fiber component. The fastening assembly provides mechanical stability to prevent displacement of the enclosure when subjected to external vibrations or pressure variations.

Further, the plurality of perforation holes is confined within the protruded section of the flexible retention sheet to localize suction forces at the fiber interface. Such confinement prevents vacuum leakage from non-utilized regions of the flexible retention sheet, thereby concentrating the retention force at the received fiber component to improve the stability of vacuum-assisted fiber positioning.

Further, the plurality of perforation holes comprises variable diameters to optimize suction force distribution for attachment of fiber components of multiple sizes. The variable diameters provide differential suction intensity, allowing fiber components with different diameters to be secured uniformly without excessive vacuum force, preventing fiber misalignment or deformation due to uneven retention pressure.

Further, a secondary sheet is positioned beneath the flexible retention sheet, wherein said secondary sheet comprises a secondary set of holes, each having a diameter smaller than the diameter of the perforation holes in the flexible retention sheet. The secondary sheet introduces an additional vacuum-sealing layer, reducing airflow disturbances and improving fiber retention efficiency by minimizing vacuum loss through the perforation holes.

Further, each hole of the secondary set of holes in the secondary sheet has a diameter smaller than the diameter of the plurality of perforation holes by a range of 10% to 30%. The defined diameter ratio allows for controlled airflow restriction, thereby enhancing the vacuum retention capability of the flexible retention sheet without introducing excessive suction forces that may lead to fiber deformation or instability.

Further, an adhesive layer is disposed between the flexible retention sheet and the internal chamber, wherein the adhesive layer secures the flexible retention sheet in place to prevent displacement during variations in induced negative pressure within the suction conduit. The adhesive layer provides additional mechanical reinforcement, preventing shifting of the flexible retention sheet that could otherwise disrupt fiber positioning during vacuum activation and deactivation cycles.

Further, the protruded section conforms to the engagement recess to establish a contoured interfacing arrangement. Such contouring enhances the structural stability of the flexible retention sheet within the enclosure, preventing misalignment caused by uneven vacuum distribution.

Further, a buffer pad is positioned between the flexible retention sheet and the fiber component, wherein the buffer pad comprises alignment openings corresponding to the perforation holes to accommodate fiber components with multiple cladding diameters. The buffer pad provides additional structural support by aligning the fiber component within the retention area while preventing direct contact with the flexible retention sheet, thereby reducing the risk of fiber damage.

Further, a plurality of fiber positioning apparatuses is mounted in a parallel configuration, wherein each fiber positioning apparatus operates independently to secure fiber components through vacuum-assisted retention. The parallel configuration enables high-density fiber positioning by allowing multiple fiber components to be held in proximity while maintaining individual vacuum control, preventing cross-interference between adjacent fiber components.

Further, a surfacing layer is formed on the flexible retention sheet, wherein the surfacing layer comprises a textured structure configured to enhance frictional engagement with each received fiber component. The textured structure prevents slippage of fiber components within the flexible retention sheet by increasing surface contact friction.

Further, the flexible retention sheet is molded with pre-defined fiber grooves, wherein the pre-defined fiber grooves facilitate alignment of each fiber component within the flexible retention sheet. The grooves provide a dedicated seating area for fiber components, preventing lateral shifting and maintaining uniform spacing between adjacent fibers, thereby enhancing the accuracy of fiber positioning.

Further, an adjuster is configured to modify the positioning of at least one fiber component relative to the flexible retention sheet. The adjuster enables fine-tuned realignment of fiber components after initial placement, allowing precise control over fiber spacing and orientation within the fiber positioning apparatus to optimize experimental or operational configurations.

Further, the enclosure comprises an internal reinforcement layer extending parallel to the internal chamber, wherein the internal reinforcement layer is engaged with the engagement recess to enhance structural rigidity and prevent deformation under vacuum pressure. The reinforcement layer provides mechanical stability to prevent bending or warping of the enclosure.

Further, the plurality of vacuum channels is arranged in a symmetrical alignment structure, wherein the symmetrical alignment structure prevents asymmetrical suction forces that misalign the fiber component. The symmetrical alignment of vacuum channels enables uniform suction force distribution, preventing variations in fiber retention pressure that may lead to misalignment or fiber instability.

Further, the suction conduit comprises a flow-adjusting interface, wherein the flow-adjusting interface modulates the vacuum suction levels based on the positioning of the fiber component. The flow-adjusting interface allows controlled suction regulation to prevent excessive vacuum forces from being applied to fiber components, reducing stress-induced deformations.

Further, the internal chamber comprises a pressure-relief section, wherein the pressure-relief section prevents vacuum-induced stress by redirecting residual airflow away from the plurality of vacuum channels. The pressure-relief section maintains a balanced pressure environment within the enclosure, preventing excessive force buildup that could displace or misalign fiber components.

Further, the engagement recess comprises a fiber-positioning guide section, wherein the fiber-positioning guide section enables controlled lateral positioning of the fiber component within the flexible retention sheet. The guide section prevents lateral shifting of fiber components within the vacuum retention area.

Further, a cover is positioned over the flexible retention sheet, wherein the cover encloses the flexible retention sheet to regulate airflow across the plurality of perforation holes and maintain uniform negative pressure distribution for securing each received fiber component. The cover prevents external air disturbances from affecting vacuum retention.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 to FIG. 4 illustrates the prior arts of controlling the position of the optical fibers, in accordance with the embodiments of the present disclosures;

FIG. 5 illustrates a fiber positioning apparatus, in accordance with various implementations of the present disclosure;

FIG. 6 illustrates a method for securing at least one fiber component within a fiber positioning apparatus, in accordance with embodiments of the present disclosure;

FIG. 7 illustrates a fiber positioning apparatus mounted on a structural component, which provides support and stability for fiber positioning operations, in accordance with various implementations of the present disclosure;

FIG. 8 illustrates a sectional view of fiber positioning apparatus, in accordance with various implementations of the present disclosure; and

FIG. 9 illustrates a fiber positioning apparatus facilitating the alignment of fiber components by optimizing the pitch between fiber components, in accordance with various implementations of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

As used herein, the term “fiber positioning apparatus” refers to a system for securing, positioning, and aligning at least one fiber component using vacuum-assisted retention. Such fiber positioning apparatus comprises an enclosure, a flexible retention sheet, a suction conduit, and an engagement recess, which collectively function to generate and maintain negative pressure for fiber retention. The fiber positioning apparatus is employed in various optical, telecommunications, and scientific applications where precise fiber alignment is required. The fiber positioning apparatus facilitates fiber placement in configurations such as optical interconnects, fiber-optic testing environments, and controlled laboratory settings where fiber stability is a key requirement. The fiber positioning apparatus may be used in single-fiber arrangements or multi-fiber configurations, where multiple fiber positioning apparatuses are arranged in parallel to achieve high-density fiber alignment.

As used herein, the term “enclosure” refers to a structural housing that contains and supports internal components of the fiber positioning apparatus. Such enclosure defines an internal chamber for accommodating the flexible retention sheet and suction conduit. The enclosure may be constructed from materials such as metal, polymer, or composite structures to provide mechanical strength and environmental protection. The enclosure may feature openings, recesses, or mounting points that allow for integration with additional components such as fastening assemblies, attachment interfaces, and external vacuum sources. In applications requiring precision fiber alignment, the enclosure provides a stable framework that prevents displacement of internal components during vacuum operation. The enclosure may comprise reinforcement layers or structural supports that minimize deformation under applied pressure. The enclosure can be adapted for different mounting configurations, including table-mounted systems, wall-mounted systems, and modular enclosures that integrate with larger optical or experimental setups.

As used herein, the term “internal chamber” refers to an enclosed cavity within the enclosure that accommodates and supports the flexible retention sheet. Such internal chamber serves as a containment space where the flexible retention sheet is positioned to interact with the suction conduit. The internal chamber facilitates uniform vacuum distribution across the flexible retention sheet. The internal chamber may comprise structural reinforcements, airflow control features, or integrated guides that assist in the proper placement and retention of fiber components. In applications requiring multiple fiber positions, the internal chamber may be subdivided into sections that independently regulate vacuum levels for each fiber position. The internal chamber may be sealed or vented depending on the level of vacuum control required.

As used herein, the term “engagement recess” refers to a structural cavity within the enclosure that accommodates the protruded section of the flexible retention sheet. Such engagement recess facilitates a secure interface between the flexible retention sheet and the enclosure by providing a contoured receiving area that aligns with the flexible retention sheet. The engagement recess serves to stabilize the flexible retention sheet and minimize air leakage that may compromise vacuum retention. The engagement recess may be contoured, stepped, or depth-graded to provide mechanical support while allowing airflow regulation between the suction conduit and the flexible retention sheet.

As used herein, the term “attachment interface” refers to a structural surface or mounting feature located on the outer portion of the enclosure, facilitating secure attachment to a support structure. Such attachment interface provides mechanical stability to the fiber positioning apparatus by preventing unintended displacement during operation. The attachment interface may comprise features such as threaded inserts, mounting holes, clamps, or brackets that enable attachment to laboratory benches, optical systems, or modular fixtures. The attachment interface may be adjustable to accommodate different installation orientations. The attachment interface may incorporate quick-release mechanisms that allow for rapid repositioning or replacement of the fiber positioning apparatus.

As used herein, the term “flexible retention sheet” refers to a compliant structural layer extending through the internal chamber of the enclosure, providing an interface for receiving and retaining fiber components using vacuum-assisted attachment. Such flexible retention sheet conforms to the engagement recess, enabling a secure vacuum seal while allowing for controlled positioning of fiber components. The flexible retention sheet comprises a plurality of perforation holes that facilitate vacuum transmission for fiber retention. The flexible retention sheet may be fabricated from materials such as elastomers, flexible polymers, or composite layers that allow for both deformation under vacuum and recovery upon vacuum release. The flexible retention sheet is utilized in applications requiring non-permanent fiber retention, where fiber components must be held securely while allowing for repositioning or replacement without adhesive bonding. The flexible retention sheet may incorporate additional features such as surface texturing, fiber-guiding structures, or reinforcement layers to enhance vacuum retention and fiber stability.

As used herein, the term “suction conduit” refers to a passageway or channel extending along a portion of the enclosure, fluidically connecting the engagement recess to an external vacuum source. Such suction conduit facilitates negative pressure generation within the flexible retention sheet by establishing airflow pathways that regulate vacuum distribution. The suction conduit may be a rigid or flexible structure, incorporating airflow control elements such as valves, pressure regulators, or adjustable inlets that modulate suction intensity. The suction conduit may be connected to centralized vacuum systems or independent vacuum pumps, depending on application requirements. The suction conduit may comprise modular connectors that allow integration with multiple vacuum systems. The suction conduit may be internally or externally routed depending on enclosure constraints.

As used herein, the term “vacuum source” refers to an external device or system responsible for generating negative pressure within the suction conduit. Such vacuum source facilitates fiber retention by maintaining sufficient suction force through the perforation holes of the flexible retention sheet. The vacuum source may comprise mechanical vacuum pumps, pneumatic ejectors, or centralized vacuum distribution systems that provide adjustable suction levels. The vacuum source may be activated or deactivated based on operational requirements, allowing for controlled attachment and release of fiber components. The vacuum source may be configured to operate under continuous suction or pulsed vacuum conditions, depending on fiber positioning needs. The vacuum source may comprise safety features such as pressure sensors, automated shutoff mechanisms, or vacuum reservoirs that maintain stable suction levels during operation.

As used herein, the term “perforation holes” refers to openings extending through the flexible retention sheet, facilitating airflow transmission between the suction conduit and fiber components. Such perforation holes enable negative pressure to be applied directly to fiber components, securing them against the flexible retention sheet. The perforation holes may be arranged in a uniform or variable pattern, allowing for optimized vacuum force distribution. The perforation holes may be dimensioned to accommodate different fiber diameters, preventing excessive vacuum force from distorting fiber geometry. The perforation holes may be selectively activated or deactivated based on fiber positioning needs.

As used herein, the term “fiber component” refers to an optical or structural fiber that is positioned within the fiber positioning apparatus for alignment, testing, or interconnection. Such fiber component may comprise telecommunications fibers, experimental optical fibers, or fiber bundles requiring controlled positioning. The fiber component may be a single fiber, or an array of multiple fibers arranged in a defined configuration. The fiber component may require precise positioning for applications such as optical signal transmission, fiber coupling, or experimental measurements. The fiber component may be held in place temporarily or semi-permanently, depending on vacuum retention settings.

As used herein, the term “negative pressure” refers to the suction force applied through the perforation holes of the flexible retention sheet to retain fiber components. Such negative pressure is generated by the vacuum source and maintained through the suction conduit. Negative pressure facilitates fiber attachment while allowing for controlled release when vacuum is deactivated. Negative pressure may be adjusted based on fiber retention requirements, enabling secure positioning without excessive force.

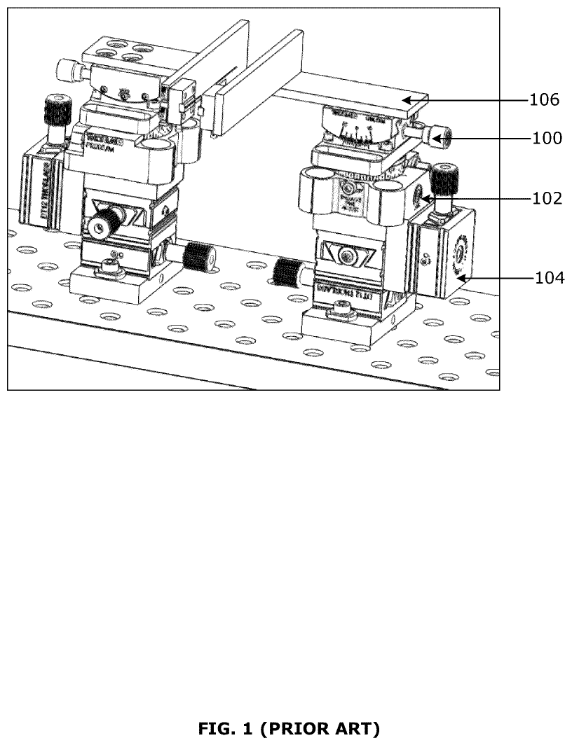

FIG. 1 to FIG. 4 illustrates the prior arts of controlling the position of the optical fibers, in accordance with the embodiments of the present disclosures. FIG. 1 illustrates a fiber positioning approach using a positioning stage (100) that enables translation and rotation of a fiber-holding assembly. A movement mechanism (102) provides controlled adjustment, and a base platform (104) serves as structural support. A clamping structure (106) stabilizes the fiber-holding assembly in position. Manual operation involves direct intervention for alignment, while motorized actuation facilitates controlled displacement. The arrangement provides adaptability for fiber alignment, though mechanical wear and external factors introduce challenges in maintaining stable positioning. Vibrational disturbances may impact accuracy, requiring additional stabilization measures for sustained fiber retention.

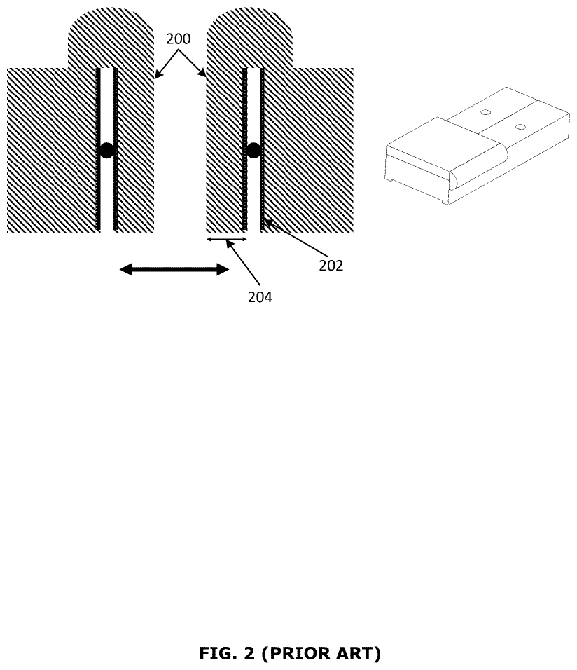

FIG. 2 illustrates a mechanical clamp (200) that consists of two opposing clamping sections (202) forming a structural recess for fiber retention. A fastening mechanism (204) enables force application to secure the fiber in place. The clamp structure limits lateral movement while allowing axial positioning. Controlled force application is required to prevent excessive compression that may lead to fiber deformation. The clamping mechanism utilizes a spring-loaded or screw-based tightening approach to achieve secure retention. Manual adjustments influence reconfiguration efficiency, requiring calibrated engagement to maintain positioning accuracy.

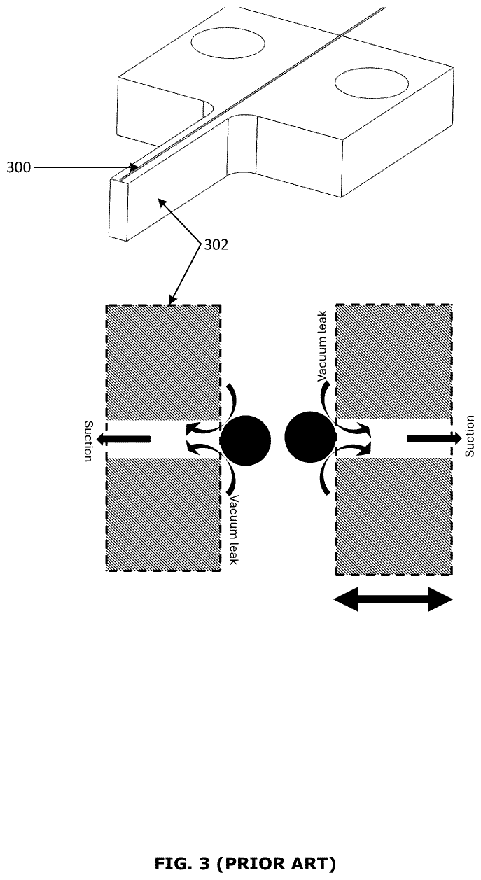

FIG. 3 illustrates a vacuum clamp incorporating a fiber channel (300) within a rigid block (302) for fiber retention. A vacuum source generates suction within the fiber channel (300) to retain the fiber without direct mechanical stress. The vacuum-assisted mechanism reduces the likelihood of fiber deformation but introduces vacuum leakage due to fiber geometry. Continuous suction application is required to sustain retention. Environmental variations, including temperature and pressure fluctuations, may influence vacuum stability, affecting fiber positioning consistency.

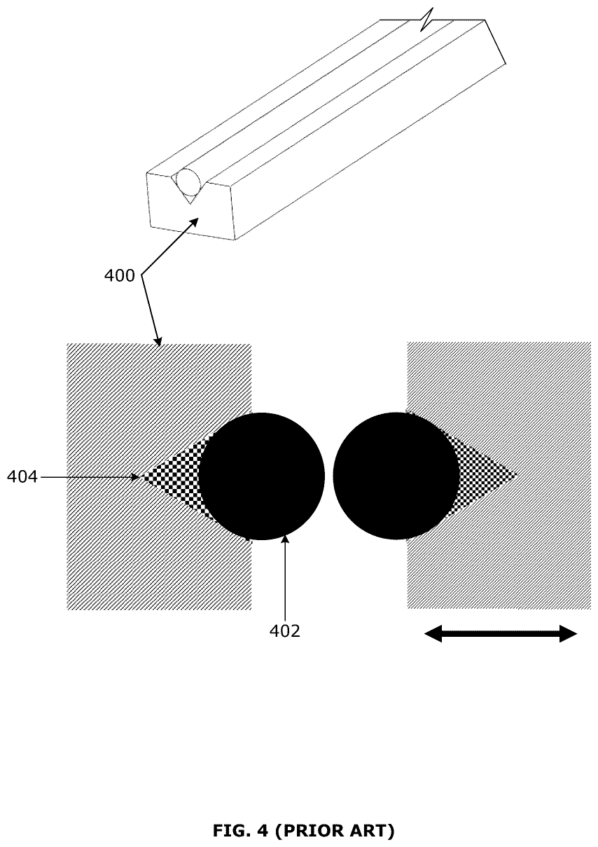

FIG. 4 illustrates a fiber-holding structure incorporating a V-groove block (400) with a positioning groove for fiber alignment. A fiber component (402) is positioned within the V-groove block (400) to restrict lateral displacement. An adhesive layer (404) is applied within the groove to secure the fiber permanently. The bonded structure prevents fiber repositioning, limiting adaptability in applications requiring reconfiguration. The adhesive layer (404) maintains mechanical fixation but prevents reuse, necessitating fiber replacement for each adjustment. The arrangement stabilizes alignment but does not allow modifications once bonding occurs.

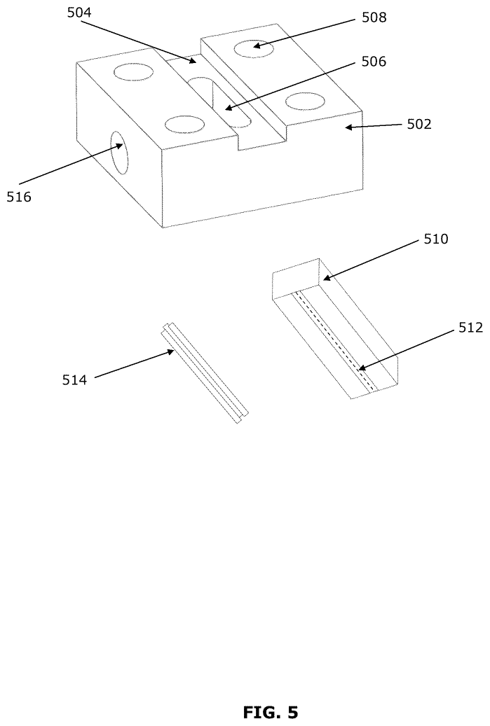

FIG. 5 illustrates a fiber positioning apparatus (500), in accordance with various implementations of the present disclosure. The fiber positioning apparatus (500) comprises an enclosure (502) that defines a structural housing for supporting internal components. The enclosure (502) comprises an internal chamber (504) that accommodates a flexible retention sheet (510) and a suction conduit (516). The enclosure (502) further comprises an engagement recess (506) extending along a portion of the internal chamber (504). The engagement recess (506) provides a receiving section that stabilizes the flexible retention sheet (510). The enclosure (502) comprises an attachment interface (508) positioned on an outer surface of the enclosure (502). The attachment interface (508) provides structural support for securing the enclosure (502) onto a support structure. The enclosure (502) may be constructed from materials such as metal, polymer, or composite structures to provide mechanical strength and environmental protection. The enclosure (502) may feature openings, recesses, or mounting points that allow for integration with additional components such as fastening assemblies or external vacuum sources. The enclosure (502) may comprise reinforcement layers or structural supports that minimize deformation under applied pressure. The enclosure (502) can be adapted for different mounting configurations, including table-mounted systems, wall-mounted systems, and modular enclosures that integrate with larger optical or experimental setups.

In an embodiment, the internal chamber (504) is positioned within the enclosure (502) and provides a cavity that houses the flexible retention sheet (510). The internal chamber (504) facilitates airflow distribution for uniform vacuum retention. The internal chamber (504) extends along the length of the enclosure (502) and is dimensioned to accommodate the flexible retention sheet (510) in a secure manner. The internal chamber (504) may be formed with structural reinforcements to prevent deformation under vacuum conditions. The internal chamber (504) may further comprise sealing elements along its perimeter to prevent vacuum leakage. The internal chamber (504) may be subdivided into sections that allow for independent vacuum regulation for different fiber positioning areas. The internal chamber (504) may also comprise alignment features to position the flexible retention sheet (510) in a predetermined orientation. The internal chamber (504) may incorporate surface treatments that improve airflow dynamics to regulate vacuum distribution. The internal chamber (504) may be accessible through removable panels or access points to facilitate maintenance or reconfiguration.

In an embodiment, the engagement recess (506) is a structural cavity formed within the enclosure (502) that extends along a portion of the internal chamber (504). The engagement recess (506) is shaped to receive a protruded section of the flexible retention sheet (510). The engagement recess (506) provides mechanical support by securing the flexible retention sheet (510) in place. The engagement recess (506) may be contoured to conform to the flexible retention sheet (510) to minimize air leakage and maintain vacuum integrity. The engagement recess (506) may comprise grooves, slots, or stepped surfaces that enhance retention of the flexible retention sheet (510). The engagement recess (506) may be constructed with variations in depth or width to accommodate different fiber positioning configurations. The engagement recess (506) may further comprise sealing structures that regulate airflow and improve vacuum retention. The engagement recess (506) may be integrated with additional mounting elements that reinforce the positioning of the flexible retention sheet (510).

In an embodiment, the attachment interface (508) is positioned on an outer surface of the enclosure (502) and facilitates secure attachment of the fiber positioning apparatus (500) onto a support structure. The attachment interface (508) comprises mounting features that provide stability and prevent displacement during operation. The attachment interface (508) may comprise threaded inserts, clamps, brackets, or mechanical fasteners that secure the enclosure (502) to a laboratory surface or experimental setup. The attachment interface (508) may be positioned at one or multiple locations along the outer surface of the enclosure (502) to provide different mounting orientations. The attachment interface (508) may be adjustable to allow for alignment modifications depending on application requirements. The attachment interface (508) may be integrated with a fastening assembly that comprises locking mechanisms to enable a secure connection to a support structure. The attachment interface (508) may be reinforced to withstand mechanical stresses that may occur due to environmental factors or external forces.

In an embodiment, the flexible retention sheet (510) extends through the internal chamber (504) and provides an interface for receiving at least one fiber component (514). The flexible retention sheet (510) comprises a protruded section that extends into the engagement recess (506). The flexible retention sheet (510) comprises a plurality of perforation holes (512) extending through the flexible retention sheet (510) to facilitate vacuum retention. The flexible retention sheet (510) is constructed from compliant materials such as elastomers, flexible polymers, or composite layers that allow deformation under vacuum while maintaining fiber positioning stability. The flexible retention sheet (510) may comprise reinforcement layers to improve mechanical strength while allowing flexibility for accommodating different fiber configurations. The flexible retention sheet (510) may incorporate surface treatments that enhance grip to prevent fiber displacement. The flexible retention sheet (510) may be manufactured with a variable thickness to optimize vacuum distribution. The flexible retention sheet (510) may include pre-defined fiber grooves to facilitate alignment of fiber components (514) within the fiber positioning apparatus (500).

In an embodiment, the plurality of perforation holes (512) extends through the flexible retention sheet (510) and provides airflow pathways that allow vacuum transmission from the suction conduit (516) to the fiber components (514). The perforation holes (512) are positioned in a pattern that assures uniform vacuum retention across the flexible retention sheet (510). The perforation holes (512) may be arranged in a linear, grid, or radial configuration depending on fiber positioning requirements. The perforation holes (512) may comprise different diameters to regulate vacuum pressure for fiber components (514) of varying sizes. The perforation holes (512) may be selectively activated or deactivated based on airflow control mechanisms integrated into the suction conduit (516). The perforation holes (512) may comprise features such as tapered edges or airflow diffusers to regulate suction forces applied to fiber components (514). The perforation holes (512) may be reinforced with additional structural elements that prevent material deformation under vacuum forces.

In an embodiment, the suction conduit (516) is fluidically coupled to the engagement recess (506) and extends along a portion of the enclosure (502). The suction conduit (516) establishes fluid communication with each perforation hole (512) and provides airflow pathways for generating negative pressure. The suction conduit (516) is connected to a vacuum source that induces negative pressure within the flexible retention sheet (510). The suction conduit (516) may comprise adjustable valves, flow regulators, or pressure control elements that modulate suction intensity based on fiber positioning requirements. The suction conduit (516) may be integrated with pressure sensors that monitor vacuum levels to maintain stable fiber retention. The suction conduit (516) may be routed internally or externally depending on enclosure (502). The suction conduit (516) may incorporate modular connectors that facilitate integration with different vacuum systems. The suction conduit (516) may comprise flexible tubing, rigid conduits, or hybrid airflow channels that accommodate different vacuum configurations.

In an embodiment, the vacuum source is coupled to the suction conduit (516) and provides negative pressure that induces attachment of each received fiber component (514) to the flexible retention sheet (510). The vacuum source generates a suction force that transmits through the suction conduit (516) and perforation holes (512) to secure the fiber components (514) in position. The vacuum source may comprise a mechanical vacuum pump, pneumatic ejector, or centralized vacuum distribution system. The vacuum source may operate under continuous suction or controlled pulsation to regulate fiber retention and release. The vacuum source may be integrated with automated vacuum control systems that adjust suction intensity based on fiber alignment requirements. The vacuum source may comprise safety mechanisms such as pressure-relief valves or automated shutoff controls that prevent excessive suction forces. The vacuum source may provide adjustable vacuum pressure to accommodate fiber components (514) of different diameters without inducing excessive mechanical stress. The vacuum source may comprise reservoir systems that maintain stable vacuum retention even under fluctuating operating conditions. The vacuum source facilitates attachment of fiber components (514) to the flexible retention sheet (510) for the duration of induced negative pressure. The vacuum source allows for controlled release of fiber components (514) by deactivating suction, enabling repositioning or removal as required.

In an embodiment, the attachment interface (508) may be secured to a support structure through a fastening assembly that is positioned along the attachment interface (508). The fastening assembly provides mechanical stability by preventing unintended displacement of the enclosure (502) during operation. The fastening assembly may comprise mechanical fasteners such as screws, bolts, or clamps that engage with corresponding mounting features on the support structure. The fastening assembly may comprise a locking mechanism that prevents loosening due to vibrations or external forces. The fastening assembly may be integrated with an adjustable mounting bracket that allows modification of the position of the enclosure (502) relative to the support structure. The fastening assembly may further comprise shock-absorbing elements that mitigate the impact of external forces applied to the fiber positioning apparatus (500). The fastening assembly may be positioned at multiple locations along the attachment interface (508) to provide additional points of contact with the support structure. The fastening assembly may be constructed from materials such as stainless steel, aluminum, or polymer composites, depending on application-specific requirements. The fastening assembly may allow quick attachment and detachment of the enclosure (502) for reconfiguration or maintenance. The fastening assembly may further comprise alignment guides that facilitate precise positioning of the enclosure (502) on the support structure. The fastening assembly may comprise an anti-rotation mechanism that prevents unintended movement of the enclosure (502) after securing the attachment interface (508) to the support structure.

In an embodiment, the plurality of perforation holes (512) may be confined within the protruded section of the flexible retention sheet (510). The confinement of the perforation holes (512) within the protruded section makes sure that the airflow pathways for vacuum transmission remain localized to a specific region of the flexible retention sheet (510). The protruded section of the flexible retention sheet (510) engages with the engagement recess (506) to provide a sealed interface that minimizes vacuum leakage. The confinement of the perforation holes (512) prevents airflow disruptions that may occur if the perforation holes (512) were distributed across an unconfined surface. The perforation holes (512) may be arranged in a linear, grid, or patterned configuration within the protruded section to optimize vacuum distribution. The confinement of the perforation holes (512) within the protruded section allows for controlled suction application, making sure that vacuum force is applied directly to fiber components (514) without unintended air leakage. The confinement of the perforation holes (512) also facilitates uniform airflow regulation within the flexible retention sheet (510), preventing localized pressure variations that may affect fiber positioning. The protruded section may include a contoured surface to further regulate vacuum retention by forming a conformal contact with fiber components (514). The perforation holes (512) may be dimensioned to correspond with the fiber components (514) that are positioned on the flexible retention sheet (510), assuring compatibility with multiple fiber sizes. The confinement of the perforation holes (512) within the protruded section also enables alignment precision by limiting the vacuum retention area to a predefined region of the flexible retention sheet (510).

In an embodiment, the plurality of perforation holes (512) may comprise variable diameters, wherein the variable diameters optimize a suction force distribution for attachment of the fiber components (514) of multiple sizes. The variation in diameters among the perforation holes (512) allows differential vacuum force application, making sure that fiber components (514) of different dimensions receive appropriate suction levels. The perforation holes (512) with larger diameters may be positioned at specific locations where higher vacuum retention is required, while perforation holes (512) with smaller diameters may be used to provide lower suction levels. The variable diameters of the perforation holes (512) enable balanced airflow distribution, preventing excessive suction that may cause fiber deformation. The arrangement of the variable-diameter perforation holes (512) may be determined based on expected fiber positioning requirements. The perforation holes (512) may be distributed in a pattern that accommodates fiber components (514) of varying thicknesses without requiring additional modifications to the flexible retention sheet (510). The variation in perforation holes (512) diameters may be implemented through manufacturing techniques such as laser drilling, molding, or precision machining. The perforation holes (512) with variable diameters may be positioned based on an optimized suction mapping approach, assuring that each fiber component (514) experiences a controlled vacuum force. The perforation holes (512) may also be arranged in different zones, with each zone comprising perforation holes (512) of specific diameters for different fiber types.

In an embodiment, a secondary sheet is positioned beneath the flexible retention sheet (510), wherein the secondary sheet comprises a secondary set of holes, each having a diameter smaller than the diameter of the plurality of perforation holes (512). The secondary sheet provides an additional vacuum-sealing layer that regulates airflow through the perforation holes (512). The secondary set of holes in the secondary sheet aligns with the perforation holes (512) to enable proper airflow distribution while minimizing vacuum loss. The secondary sheet may be fabricated from materials such as polymer films, elastomers, or composite layers that provide flexibility and durability. The secondary sheet acts as a stabilizing interface that prevents excessive deformation of the flexible retention sheet (510) under vacuum pressure. The secondary sheet may be attached to the flexible retention sheet (510) using adhesion, mechanical fasteners, or compression fitting. The secondary sheet may further comprise surface texturing that enhances vacuum retention by improving contact with fiber components (514). The secondary sheet allows for controlled air passage, making sure that vacuum force remains consistent across the fiber positioning apparatus (500). The secondary sheet may be replaceable, allowing for different secondary set of hole (512) configurations depending on fiber component (514) retention requirements. The secondary sheet also serves as an additional alignment feature, making sure that fiber components (514) remain in a predefined position during vacuum operation. The secondary sheet may comprise integrated reinforcement sections that provide structural support to the flexible retention sheet (510). The secondary sheet may also contribute to uniform suction distribution by preventing unintended vacuum variations.

In an embodiment, each hole of the secondary set of holes in the secondary sheet has a diameter smaller than the diameter of the plurality of perforation holes (512) by a range of 10% to 30% (selected from distinct ranges such as 10% to 15%, 16% to 24% and 25% to 30%). The controlled size reduction of the secondary set of holes provides a calibrated airflow restriction mechanism that regulates vacuum intensity applied to fiber components (514). The diameter variation between the perforation holes (512) and the secondary set of holes prevents excessive vacuum force from being exerted on fiber components (514), reducing the risk of fiber deformation. The smaller diameter of the secondary set of holes allows for finer control over suction force by introducing an intermediate vacuum chamber within the fiber positioning apparatus (500). The 10% to 30% reduction range is selected to balance vacuum retention efficiency while preventing excessive restriction that may hinder vacuum transmission. The secondary set of holes may be configured in different patterns, including uniform or variable spacing arrangements, depending on fiber positioning requirements. The diameter variation between the perforation holes (512) and the secondary set of holes also improves vacuum stabilization by preventing sudden pressure fluctuations. The manufacturing process for the secondary set of holes may comprise precision punching, laser cutting, or micro-drilling to achieve the required dimensional accuracy. The reduced diameter of the secondary set of holes allows for enhanced control over fiber retention by moderating the vacuum force distribution. The range of 10% to 30% for the diameter reduction of the secondary set of holes relative to the perforation holes (512) is significant because of providing controlled airflow restriction, enabling balanced vacuum retention while preventing excessive suction force on fiber components (514). A reduction below 10% may lead to inadequate vacuum modulation, causing inefficient fiber retention, while a reduction exceeding 30% may overly restrict airflow, leading to unstable suction distribution.

In an embodiment, an adhesive layer may be disposed between the flexible retention sheet (510) and the internal chamber (504), wherein the adhesive layer secures the flexible retention sheet (510) in place to prevent displacement during variations in induced negative pressure within the suction conduit (516). The adhesive layer provides a continuous bonding interface that maintains a sealed connection between the flexible retention sheet (510) and the internal chamber (504). The adhesive layer may be selected based on material compatibility, enabling effective adhesion without affecting the flexibility of the flexible retention sheet (510). The adhesive layer may comprise pressure-sensitive adhesives, epoxy-based adhesives, or silicone-based adhesives depending on environmental and operational conditions. The adhesive layer may be applied in a uniform or patterned distribution to regulate bonding strength while allowing controlled airflow passage where required. The adhesive layer may comprise a moisture-resistant formulation to prevent degradation due to environmental exposure. The adhesive layer may provide structural reinforcement that minimizes shifting or deformation of the flexible retention sheet (510) under vacuum pressure. The adhesive layer may be heat-activated or pressure-activated to achieve a secure bond without introducing excessive rigidity. The adhesive layer may comprise a removable or reworkable formulation, allowing adjustments or replacements of the flexible retention sheet (510) without damaging the internal chamber (504). The adhesive layer may further comprise a non-conductive formulation to prevent interference with fiber r components (514) that require electromagnetic shielding or insulation.

In an embodiment, the protruded section may conform to the engagement recess (506) to establish a contoured interfacing arrangement. The engagement recess (506) is shaped to receive the protruded section of the flexible retention sheet (510), allowing a stable mechanical fit that minimizes unintended movement. The contoured interfacing arrangement enhances vacuum retention by maintaining an airtight connection between the flexible retention sheet (510) and the engagement recess (506). The engagement recess (506) may comprise a depth-graded surface that accommodates the protruded section in a manner that optimizes airflow regulation. The engagement recess (506) may comprise a stepped or tapered profile that aligns with the flexible retention sheet (510) to prevent localized stress accumulation. The protruded section of the flexible retention sheet (510) may be manufactured with a flexible or semi-rigid material to maintain a conformal fit within the engagement recess (506). The protruded section may be reinforced with embedded support layers that maintain shape stability during repeated vacuum activation cycles. The engagement recess (506) may comprise a sealing layer or gasket positioned between the protruded section and the recess surface to regulate vacuum loss and improve retention efficiency. The engagement recess (506) may further comprise structural guide elements that maintain alignment during installation or replacement of the flexible retention sheet (510). The engagement recess (506) may be formed with an adjustable mounting profile that allows fine-tuned positioning of the protruded section to accommodate fiber component (514) variations.

In an embodiment, a buffer pad may be positioned between the flexible retention sheet (510) and the fiber component (514), wherein the buffer pad comprises alignment openings corresponding to the perforation holes (512) to accommodate the fiber components (514) with multiple cladding diameters. The buffer pad provides an additional interface that stabilizes the fiber component (514) during vacuum retention. The buffer pad is constructed from compliant materials such as elastomers, foamed polymers, or fabric composites that allow controlled deformation under vacuum pressure while maintaining fiber positioning. The alignment openings in the buffer pad are dimensioned to correspond with the perforation holes (512), making sure consistent airflow distribution. The buffer pad may comprise a textured surface that reduces fiber component (514) movement while allowing controlled placement adjustments. The buffer pad may be removably positioned to allow replacement or reconfiguration based on fiber component (514) size requirements. The buffer pad may comprise embedded support layers that prevent material fatigue under repeated vacuum cycling. The alignment openings of the buffer pad may comprise chamfered or contoured edges to facilitate fiber component (514) insertion without causing damage. The buffer pad may further comprise anti-static properties to prevent dust accumulation that could interfere with fiber component (514) placement. The buffer pad may be treated with a surface coating that minimizes friction to allow precise fiber positioning adjustments. The buffer pad may be integrated with a multi-layer design that accommodates different fiber component (514) cladding diameters within a single structure.

In an embodiment, two or more fiber positioning apparatuses (500) may be mounted in a parallel configuration, wherein each fiber positioning apparatus (500) operates independently to secure the fiber components (514) through vacuum-assisted retention. The parallel configuration allows multiple fiber components (514) to be positioned with controlled spacing while maintaining individual vacuum regulation for each fiber positioning apparatus (500). The fiber positioning apparatuses (500) may be secured onto a shared support structure that maintains positional stability. Each fiber positioning apparatus (500) may comprise an independent suction conduit (516) that allows adjustable vacuum retention based on fiber component (514) placement. The parallel configuration may accommodate different fiber component (514) arrangements, including linear arrays, staggered positioning, or customized spacing for specific optical applications. Each fiber positioning apparatus (500) may be mechanically linked using modular attachment interfaces (508) that facilitate secure alignment. The fiber positioning apparatuses (500) may be constructed with modular connections that allow additional units to be added to the configuration based on fiber positioning requirements. The vacuum retention system for each fiber positioning apparatus (500) may be regulated individually to prevent interference between adjacent fiber components (514). The parallel configuration may further comprise adjustable mounting brackets that enable controlled positioning modifications. The fiber positioning apparatuses (500) may comprise synchronization elements that affirm uniform retention force distribution when operating in a parallel arrangement.

In an embodiment, a surfacing layer may be formed on the flexible retention sheet (510), wherein the surfacing layer comprises a textured structure configured to enhance frictional engagement with each received fiber component (514). The surfacing layer provides a contact interface that stabilizes the fiber component (514) during vacuum retention. The surfacing layer may be formed using surface treatment methods such as embossing, chemical etching, or micro-patterned deposition. The surfacing layer may comprise structured patterns such as ridges, dimples, or micro-channels that regulate fiber positioning while maintaining controlled airflow. The surfacing layer may comprise anti-slip properties that reduce fiber component (514) movement without requiring additional mechanical restraints. The surfacing layer may comprise a non-abrasive material composition to prevent damage to the fiber component (514) while enabling stable placement. The surfacing layer may be applied as a continuous coating or as a selectively textured region based on fiber positioning requirements. The surfacing layer may comprise anti-static properties that prevent particle accumulation and contamination of fiber components (514). The surfacing layer may be configured with a hydrophobic or hydrophilic coating depending on environmental exposure requirements. The surfacing layer may further comprise a low-friction treatment that facilitates controlled fiber component (514) adjustments without excessive resistance. The surfacing layer may include a variable surface texture to provide customized retention properties based on fiber component (514) characteristics.

In an embodiment, the flexible retention sheet (510) may be molded with pre-defined fiber grooves, wherein the pre-defined fiber grooves facilitate alignment of each fiber component (514) within the flexible retention sheet (510). The pre-defined fiber grooves provide pathways that maintain the positioning of fiber components (514) during vacuum retention. The pre-defined fiber grooves may be dimensioned to accommodate different fiber diameters while preventing lateral displacement. The pre-defined fiber grooves may be arranged in linear, radial, or grid configurations to support various fiber component (514) arrangements. The pre-defined fiber grooves may be molded with depth variations that provide retention forces depending on fiber component (514) characteristics. The pre-defined fiber grooves may further comprise surface treatments that improve fiber stability while maintaining vacuum integrity. The pre-defined fiber grooves may be manufactured using precision molding, laser etching, or micro-machining techniques to achieve the required geometric accuracy. The pre-defined fiber grooves may comprise sloped or chamfered edges that facilitate fiber component (514) placement while reducing the risk of fiber misalignment. The pre-defined fiber grooves may incorporate anti-static coatings that prevent dust accumulation, which could interfere with fiber positioning. The pre-defined fiber grooves may be integrated with embedded support layers to improve structural stability while maintaining flexibility. The pre-defined fiber grooves may be spaced at predetermined intervals to allow controlled fiber component (514) positioning without interfering with airflow regulation.

In an embodiment, an adjuster may be configured to modify the positioning of at least one fiber component (514) relative to the flexible retention sheet (510). The adjuster allows controlled repositioning of fiber components (514) by providing mechanical or pneumatic adjustment mechanisms. The adjuster may comprise sliding guides, rotational elements, or tension-based actuators that enable fine-tuned modifications to fiber component (514) placement. The adjuster may be manually operated or integrated with automated control systems to regulate fiber positioning. The adjuster may comprise calibrated markings or reference indicators that provide visual guidance for adjusting fiber components (514) with high accuracy. The adjuster may further comprise locking mechanisms that secure fiber components (514) in a modified position after adjustment. The adjuster may incorporate micro-positioning features such as threaded fasteners or differential screws that enable controlled movement in small increments. The adjuster may be integrated with pneumatic or hydraulic actuators that provide variable positioning adjustments based on vacuum pressure levels. The adjuster may comprise anti-vibration dampening elements that prevent unintended shifts in fiber component (514) placement due to external disturbances. The adjuster may accommodate different fiber diameters while maintaining stable retention under vacuum conditions. The adjuster may be modular in construction, allowing reconfiguration or replacement depending on fiber positioning requirements. The adjuster may comprise interchangeable adjustment tools that allow customization of fiber component (514) positioning mechanisms for specific applications. The adjuster may allow dynamic modifications of fiber alignment without requiring removal or replacement of the flexible retention sheet (510).

In an embodiment, the enclosure (502) may comprise an internal reinforcement layer extending parallel to the internal chamber (504), wherein the internal reinforcement layer is engaged with the engagement recess (506) to enhance structural rigidity and prevent deformation under vacuum pressure. The internal reinforcement layer provides additional mechanical support to the enclosure (502) to maintain dimensional stability during vacuum operation. The internal reinforcement layer may be constructed from materials such as reinforced polymer composites, metal alloys, or fiber-reinforced laminates. The internal reinforcement layer may be integrated within the enclosure (502) as a continuous structural layer or as discrete reinforcement segments. The internal reinforcement layer may comprise ribs, struts, or honeycomb structures that improve load distribution while minimizing weight. The internal reinforcement layer may be bonded, mechanically fastened, or molded within the enclosure (502) to prevent separation under stress. The internal reinforcement layer may further comprise vibration-absorbing elements that reduce mechanical resonance during vacuum fluctuations. The internal reinforcement layer may be coated with a corrosion-resistant treatment to maintain structural integrity under environmental exposure. The internal reinforcement layer may comprise expansion joints or flexible sections that accommodate dimensional changes due to temperature variations. The internal reinforcement layer may further comprise alignment guides that assure proper engagement with the engagement recess (506) for enhanced mechanical stability. The internal reinforcement layer may be manufactured using precision casting, injection molding, or machining processes to achieve the required dimensional tolerances.

In an embodiment, the plurality of vacuum channels (512) may be arranged in a symmetrical alignment structure, wherein the symmetrical alignment structure prevents the asymmetrical suction forces that misalign the fiber component (514). The symmetrical alignment structure distributes vacuum pressure evenly across the flexible retention sheet (510) to enable consistent fiber retention. The vacuum channels (512) may be arranged in a mirrored, radial, or grid-based pattern to regulate airflow distribution. The vacuum channels (512) may be dimensioned to provide balanced negative pressure across different fiber positioning areas. The symmetrical alignment structure may prevent localized vacuum concentration that could cause differential suction forces leading to fiber component (514) misalignment. The symmetrical alignment structure may further comprise structural features that regulate airflow resistance to maintain uniform vacuum retention. The vacuum channels (512) may be fabricated using precision molding, laser cutting, or micro-machining techniques to enhance geometric accuracy. The vacuum channels (512) may comprise airflow regulators that allow fine-tuned control over suction force variations. The vacuum channels (512) may be spaced at predetermined intervals to maintain consistent fiber component (514) positioning. The symmetrical alignment structure may be integrated with sealing elements that prevent vacuum loss along the perimeter of the flexible retention sheet (510). The symmetrical alignment structure may comprise reinforcement elements that prevent collapse or deformation of the vacuum channels (512) under differential pressure.

In an embodiment, the suction conduit (516) may comprise a flow-adjusting interface, wherein the flow-adjusting interface modulates the vacuum suction levels based on the positioning of the fiber component (514). The flow-adjusting interface provides controlled airflow regulation to enable consistent vacuum force across the flexible retention sheet (510). The flow-adjusting interface may comprise adjustable valves, restrictors, or automated actuators that regulate vacuum pressure variations. The flow-adjusting interface may be integrated within the suction conduit (516) as a mechanical or electronic control element. The flow-adjusting interface may be manually operated or configured for automated adjustment based on real-time vacuum monitoring. The flow-adjusting interface may comprise proportional control valves that dynamically modify suction levels to accommodate different fiber components (514). The flow-adjusting interface may further comprise pressure sensors that provide feedback-based regulation of airflow intensity. The flow-adjusting interface may be constructed from polymer, metal, or composite materials to maintain durability under continuous vacuum operation. The flow-adjusting interface may allow independent adjustment of suction force across different zones of the flexible retention sheet (510). The flow-adjusting interface may be positioned at multiple points along the suction conduit (516) to enable localized vacuum modulation. The flow-adjusting interface may comprise programmable settings that allow predefined vacuum levels to be selected based on fiber positioning requirements. The flow-adjusting interface may further comprise airflow dampeners that reduce vacuum-induced oscillations.

In an embodiment, the internal chamber (504) may comprise a pressure-relief section, wherein the pressure-relief section prevents a vacuum-induced stress by redirecting residual airflow away from the plurality of vacuum channels (512). The pressure-relief section regulates pressure differentials within the internal chamber (504) to prevent excessive vacuum force from affecting the flexible retention sheet (510) or fiber components (514). The pressure-relief section may be formed as a vented structure, an integrated flow channel, or a controlled bypass passage that diverts residual airflow. The pressure-relief section may comprise calibrated openings that allow controlled pressure equalization without compromising vacuum retention. The pressure-relief section may be positioned along the internal chamber (504) to optimize airflow dynamics and prevent localized stress concentrations. The pressure-relief section may be constructed from rigid or flexible materials that withstand varying vacuum conditions. The pressure-relief section may further comprise integrated dampening elements that modulate airflow fluctuations, reducing the impact of sudden pressure changes. The pressure-relief section may be formed as a replaceable or adjustable component, allowing modification of pressure regulation characteristics based on operational requirements. The pressure-relief section may also serve to enhance vacuum stability by reducing turbulence within the vacuum channels (512).

In an embodiment, the engagement recess (506) may comprise a fiber-positioning guide section, wherein the fiber-positioning guide section enables controlled lateral positioning of the fiber component (514) within the flexible retention sheet (510). The fiber-positioning guide section provides a defined pathway that stabilizes the fiber component (514) during vacuum retention. The fiber-positioning guide section may comprise alignment features such as slots, grooves, or raised ridges that constrain lateral movement. The fiber-positioning guide section may be dimensioned to accommodate fiber components (514) of varying diameters while maintaining consistent positioning. The fiber-positioning guide section may be manufactured as an integrated part of the engagement recess (506) or as a separately attached structure. The fiber-positioning guide section may be treated with surface coatings that reduce friction to facilitate smooth fiber placement adjustments. The fiber-positioning guide section may further comprise modular inserts that allow reconfiguration based on fiber component (514) specifications. The fiber-positioning guide section may include a contoured surface profile to optimize the interaction between the fiber component (514) and the flexible retention sheet (510). The fiber-positioning guide section may provide reference markings that assist in accurate fiber placement. The fiber-positioning guide section may be constructed from durable materials that withstand repeated fiber insertions and removals. The fiber-positioning guide section may be configured to maintain controlled spacing between multiple fiber components (514), preventing unintentional contact or misalignment.

In an embodiment, a cover may be positioned over the flexible retention sheet (510), wherein the cover encloses the flexible retention sheet (510) to regulate airflow across the plurality of perforation holes (512) and maintain uniform negative pressure distribution for securing each received fiber component (514). The cover provides an enclosed environment that prevents external air disturbances from affecting vacuum retention. The cover may be constructed from transparent, semi-transparent, or opaque materials depending on application requirements. The cover may comprise airflow control elements such as perforations, vents, or adjustable openings that modulate pressure distribution. The cover may be secured to the enclosure (502) using fastening mechanisms such as latches, screws, or clips to maintain a stable attachment. The cover may further comprise sealing elements positioned along its perimeter to prevent unintended air leakage. The cover may be formed with a rigid or flexible structure, allowing adaptability to different fiber component (514) arrangements. The cover may be treated with anti-static or anti-contamination coatings to prevent dust accumulation that may interfere with fiber positioning. The cover may comprise an access panel or removable section that facilitates fiber component (514) adjustments without detaching the entire structure. The cover may include reinforced edges that improve mechanical durability while maintaining a lightweight profile.

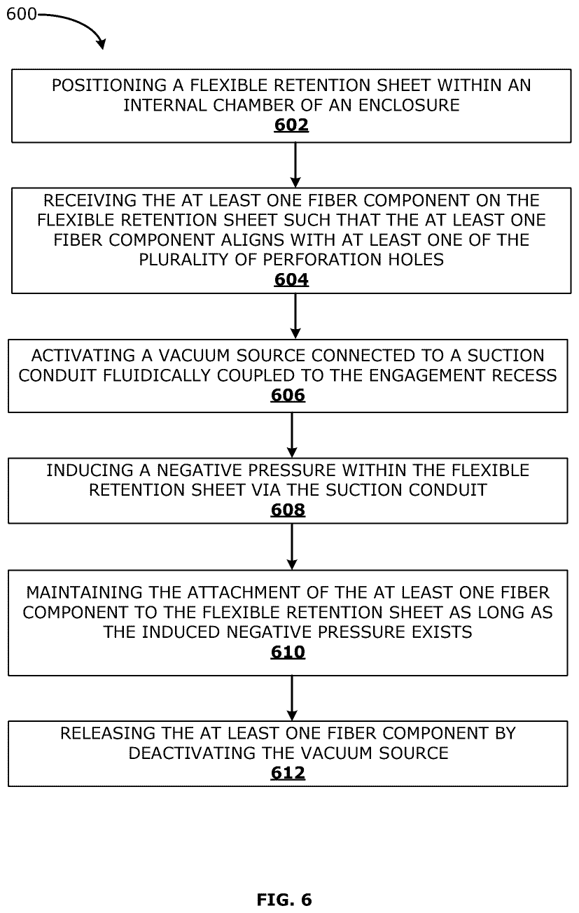

FIG. 6 illustrates a method for securing at least one fiber component (514) within a fiber positioning apparatus (500), in accordance with embodiments of the present disclosure. At step 602, a flexible retention sheet (510) is positioned within an internal chamber (504) of an enclosure (502), wherein the flexible retention sheet (510) extends through the internal chamber (504) and comprises a protruded section that is inserted into an engagement recess (506). The flexible retention sheet (510) is secured within the internal chamber (504) such that movement is restricted, preventing displacement under applied vacuum forces. The flexible retention sheet (510) comprises a plurality of perforation holes (512) that extend through the flexible retention sheet (510), allowing vacuum transmission for fiber retention. The positioning of the flexible retention sheet (510) is performed to establish alignment with the suction conduit (516), facilitating uniform negative pressure distribution. The flexible retention sheet (510) may be inserted using manual or automated placement techniques, affirming that the protruded section correctly seats within the engagement recess (506). The flexible retention sheet (510) may be secured using an adhesive layer, mechanical fasteners, or compression fittings to maintain positioning within the internal chamber (504).

At step 604, at least one fiber component (514) is received on the flexible retention sheet (510) such that the fiber component (514) aligns with at least one of the perforation holes (512). The fiber component (514) is positioned to enable proper vacuum retention and stable attachment under applied negative pressure. The fiber component (514) may be guided into position manually or using automated alignment tools that facilitate accurate placement. The flexible retention sheet (510) provides an interface for receiving fiber components (514) of varying diameters, wherein the perforation holes (512) are dimensioned to accommodate different fiber sizes. The fiber component (514) may be aligned with reference markings, pre-defined fiber grooves, or guide sections integrated into the flexible retention sheet (510). The positioning of the fiber component (514) is performed to prevent lateral movement and misalignment. The fiber component (514) is received with minimal force application to prevent structural deformation. The placement of the fiber component (514) is performed under controlled environmental conditions to prevent contamination or misalignment caused by external influences.

At step 606, a vacuum source connected to a suction conduit (516) is activated, wherein the suction conduit (516) is fluidically coupled to the engagement recess (506). The suction conduit (516) establishes fluid communication with the perforation holes (512) to enable negative pressure transmission through the flexible retention sheet (510). The vacuum source generates suction forces that propagate through the suction conduit (516) into the internal chamber (504), resulting in pressure differentials that facilitate fiber component (514) attachment. The activation of the vacuum source may be performed using a manual control mechanism, an automated system, or an integrated vacuum regulator. The suction conduit (516) may comprise a flow-adjusting interface that allows modulation of vacuum intensity, enabling controlled suction forces applied to the fiber component (514). The vacuum source activation is performed to generate a stable and uniform vacuum field within the internal chamber (504), assuring that vacuum distribution remains consistent across the perforation holes (512). The activation process may comprise airflow regulation mechanisms that prevent sudden vacuum fluctuations that could disrupt fiber positioning.

At step 608, a negative pressure is induced within the flexible retention sheet (510) via the suction conduit (516), wherein the negative pressure is transmitted through the perforation holes (512) to generate a vacuum retention force. The vacuum retention force secures the fiber component (514) against the flexible retention sheet (510), preventing displacement due to external disturbances. The negative pressure is maintained at a controlled level to prevent excessive suction forces that could lead to fiber component (514) deformation. The induced vacuum pressure distributes evenly across the flexible retention sheet (510), enabling consistent fiber retention. The vacuum retention force is regulated to match the specific retention requirements of different fiber components (514), accommodating variations in fiber diameter and structural properties. The negative pressure is applied for a duration that allows stabilization of the fiber component (514) within the fiber positioning apparatus (500). The vacuum retention force is generated based on the airflow characteristics of the suction conduit (516), making sure that pressure distribution remains uniform. The negative pressure induction is performed in a manner that prevents sudden pressure variations, minimizing the risk of misalignment.

At step 610, the attachment of the fiber component (514) to the flexible retention sheet (510) is maintained if the induced negative pressure exists. The maintained negative pressure enables continuous retention of the fiber component (514), preventing detachment due to external forces. The vacuum retention system operates within predefined pressure limits to sustain fiber positioning without causing excessive mechanical stress. The fiber component (514) remains secured against the flexible retention sheet (510) as long as vacuum forces remain active, allowing stable retention for extended periods. The pressure levels within the suction conduit (516) are monitored to assure consistent vacuum performance, preventing fluctuations that could affect fiber positioning. The maintained vacuum retention allows for stable fiber alignment within the fiber positioning apparatus (500), assuring that the fiber component (514) remains positioned for its intended application. The vacuum retention process accommodates multiple fiber components (514), allowing for simultaneous positioning of multiple fibers within the fiber positioning apparatus (500). The vacuum retention is continuously monitored to detect any variations that may require adjustments to maintain optimal fiber attachment.

At step 612, the fiber component (514) is released by deactivating the vacuum source, thereby eliminating the negative pressure within the flexible retention sheet (510). The deactivation of the vacuum source ceases suction forces transmitted through the suction conduit (516), allowing the fiber component (514) to be removed from the flexible retention sheet (510). The release of the fiber component (514) is performed in a controlled manner to prevent sudden detachment that could cause unintended displacement. The deactivation of the vacuum source may be performed using a manual control interface, an automated system, or a timed-release mechanism. The elimination of negative pressure restores the pressure balance within the internal chamber (504), allowing fiber components (514) to be repositioned or replaced. The release process is executed to prevent residual suction forces from retaining the fiber component (514) against the flexible retention sheet (510) after vacuum deactivation. The fiber component (514) is removed with minimal applied force to prevent structural damage or misalignment of subsequent fiber placements. The vacuum system may comprise a pressure-relief section that facilitates smooth pressure equalization, affirming that the fiber component (514) is released without abrupt force variations. The fiber component (514) may be repositioned, replaced, or removed entirely based on operational requirements following vacuum deactivation. The vacuum retention system may be reactivated as needed to secure a new fiber component (514) within the fiber positioning apparatus (500).

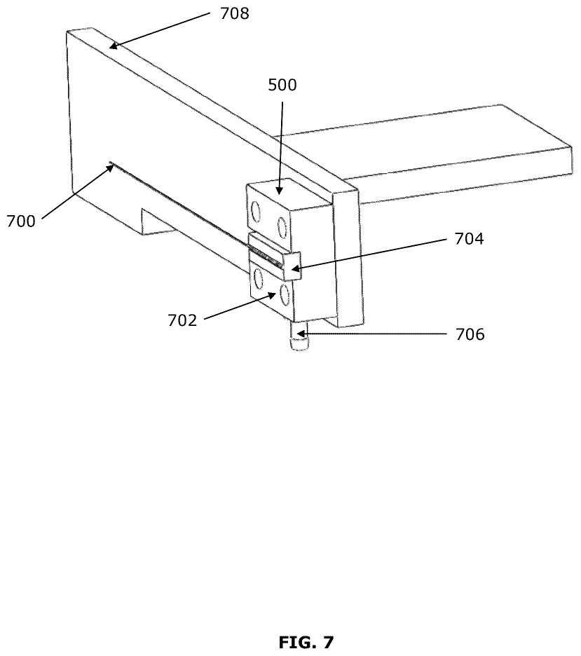

FIG. 7 illustrates a fiber positioning apparatus (500) mounted on a structural component (708), which provides support and stability for fiber positioning operations. A vacuum slot (700) facilitates suction by enabling negative pressure distribution across the fiber positioning apparatus (500). Screw holes (704) are positioned to secure the fiber positioning apparatus (500) onto a structural component (708), preventing unintended displacement during operation. A slot (704) (similar to internal chamber (504) of FIG. 5) accommodates a flexible retention sheet, enabling proper alignment within the structural assembly. A suction conduit (706) extends from the fiber positioning apparatus (500) and establishes fluid communication with the vacuum slot (700) to maintain vacuum-assisted fiber retention. The structural component (708) provides a rigid mounting interface that supports the fiber positioning apparatus (500) while making sure consistent alignment. The vacuum slot (700) operates in conjunction with the suction conduit (706) to facilitate fiber attachment using negative pressure. The structural arrangement of the fiber positioning apparatus (500) maintains fiber alignment within the slot (704), reducing positional variations that may affect retention efficiency. The attachment of the fiber positioning apparatus (500) to the structural component (708) affirms a stable mounting configuration, wherein the screw holes (704) facilitate secure fastening.

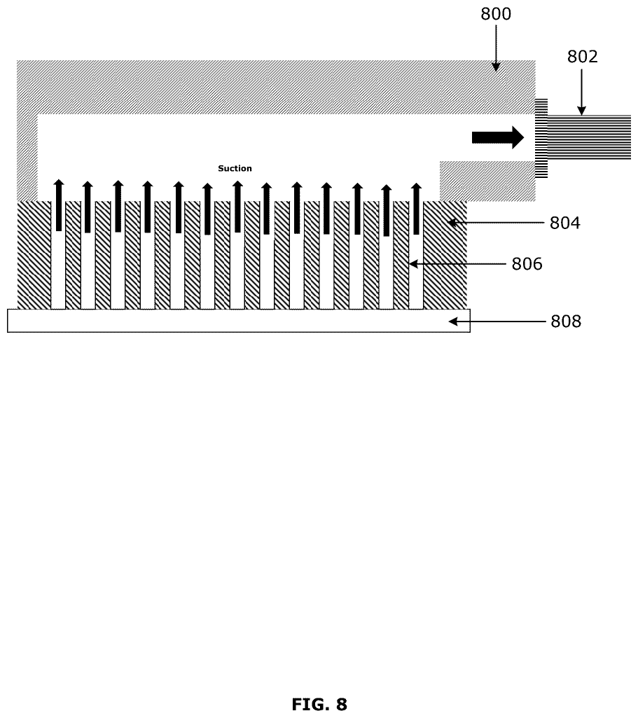

FIG. 8 illustrates a sectional view of fiber positioning apparatus (similar to the fiber positioning apparatus (500) of FIG. 5), in accordance with various implementations of the present disclosure. A flexible retention sheet (800) (similar to the flexible retention sheet (510) of FIG. 5) houses a plurality of vacuum holes (802) (similar to the perforation holes (512) of FIG. 5) that facilitate suction for securing a fiber component (similar to the at least one fiber component (514) of FIG. 5). A support structure (804) is positioned beneath the flexible retention sheet (800) to maintain structural stability. A suction conduit (806) (similar to the suction conduit (516) of FIG. 5) establishes fluid communication with the vacuum holes (802) to induce negative pressure. A base component (808) provides foundational support for the assembly. The suction conduit (806) is connected to an external vacuum source, generating suction force distributed through the vacuum holes (802) to retain the fiber component. The support structure (804) aligns the flexible retention sheet (800) within the assembly, assuring consistent positioning. The base component (808) stabilizes airflow through the suction conduit (804), maintaining uniform pressure distribution. A person ordinarily skilled in the art of fabricating the fiber positioning apparatus may utilize plurality of suction conduit (804).

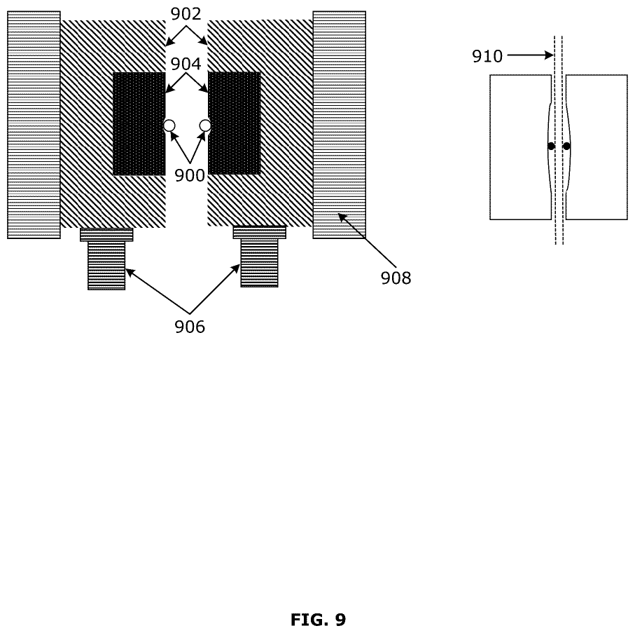

FIG. 9 illustrates a fiber positioning apparatus (902) (similar to the fiber positioning apparatus (500) of FIG. 5) facilitating the alignment of fiber components (900) (similar to the at least one fiber component (514) of FIG. 5) by optimizing the pitch between fiber components (900), in accordance with various implementations of the present disclosure. A flexible retention sheet (904) (similar to the flexible retention sheet (510) of FIG. 5 and the flexible retention sheet (800) of FIG. 8) is positioned within an enclosure (902) (similar to the enclosure (502) of FIG. 5), wherein an engagement recess (similar to the engagement recess (506) of FIG. 5) extends along an internal chamber (similar to the internal chamber (504) of FIG. 5) to accommodate the flexible retention sheet (904). A suction conduit (906) (similar to the suction conduit (516) of FIG. 5 and the suction conduit (806) of FIG. 8) is fluidically coupled to the engagement recess to establish negative pressure within the flexible retention sheet (904). A fiber component (900) is positioned between two parallelly mounted fiber positioning apparatuses (902), wherein each fiber positioning apparatus (902) retains the fiber component (900) by vacuum-assisted retention. A vacuum fitting connects the suction conduit to an external vacuum source, facilitating fiber positioning stability. A structural housing (908) encloses the fiber positioning apparatus (902) to maintain alignment. The vacuum-assisted mechanism minimizes mechanical stress on the fiber component (900) while assuring positional accuracy. A defined working distance (910) between adjacent fiber components (900) enables controlled optical analysis of fiber proximity effects. The engagement recess facilitates secure positioning within the fiber positioning apparatus (902), preventing lateral displacement during vacuum retention.

In an embodiment, enclosure (502) comprises internal chamber (504) and engagement recess (506), which facilitates stable positioning of flexible retention sheet (510) within enclosure (502). Said engagement recess (506) prevents lateral displacement of flexible retention sheet (510), maintaining alignment of fiber component (514) during vacuum-assisted retention. Said internal chamber (504) provides a confined environment to regulate airflow distribution, enabling uniform vacuum pressure across flexible retention sheet (510). Attachment interface (508) positioned on an outer surface of enclosure (502) allows for secure integration of fiber positioning apparatus (500) with a support structure, enabling precise alignment with external optical components.

In an embodiment, flexible retention sheet (510) comprises protruded section extending into engagement recess (506), affirming secure positioning within enclosure (502). Plurality of perforation holes (512) extending through flexible retention sheet (510) facilitates controlled suction force distribution, allowing uniform attachment of fiber component (514). Said perforation holes (512) enable optimized vacuum-assisted retention, minimizing displacement of fiber component (514) while reducing mechanical stress. Said flexible retention sheet (510) provides an adaptable interface for accommodating fiber component (514), enabling stable positioning within fiber positioning apparatus (500).

In an embodiment, suction conduit (516) fluidically coupled to engagement recess (506) facilitates negative pressure distribution through flexible retention sheet (510). Said suction conduit (516) establishes fluid communication with each perforation hole (512), maintaining uniform vacuum force across fiber component (514). Connection of suction conduit (516) to an external vacuum source generates controlled retention force, preventing misalignment of fiber component (514) while allowing easy release upon vacuum deactivation. Said configuration enables repeatable attachment and detachment of fiber component (514) without requiring mechanical clamping, reducing fiber deformation.

In an embodiment, attachment interface (508) secured to support structure using fastening assembly enhances mechanical stability of fiber positioning apparatus (500). Said fastening assembly makes sure rigid coupling with external mounting surfaces, preventing unintended movement during operation. Secure attachment maintains positional accuracy of fiber component (514), supporting consistent optical performance in high-density fiber arrangements.

In an embodiment, plurality of perforation holes (512) confined within protruded section of flexible retention sheet (510) enhances localized suction force distribution. Said arrangement prevents vacuum leakage along flexible retention sheet (510), improving retention efficiency of fiber component (514). Restriction of perforation holes (512) within protruded section optimizes vacuum application, reducing loss of suction force due to peripheral airflow disturbances.

In an embodiment, plurality of perforation holes (512) comprises variable diameters, allowing differential suction force distribution across flexible retention sheet (510). Said variable diameters accommodate fiber components (514) of multiple sizes, optimizing attachment force based on fiber geometry. Controlled suction modulation through varying perforation hole (512) sizes prevents excessive vacuum-induced stress on fiber component (514), preserving structural integrity during retention.

In an embodiment, secondary sheet positioned beneath flexible retention sheet (510) comprises secondary set of holes with diameters smaller than perforation holes (512). Said secondary sheet regulates airflow distribution within suction conduit (516), preventing excessive vacuum force on fiber component (514). Reduction in hole diameter within secondary sheet prevents over-suction, stabilizing attachment of fiber component (514).

In an embodiment, each hole of secondary set of holes in secondary sheet has a diameter smaller than perforation holes (512) by a range of 10% to 30%, balancing airflow resistance and suction force. Said range optimizes vacuum retention efficiency while minimizing structural deformation of fiber component (514). Controlled reduction in hole diameter prevents excessive airflow variation, maintaining stable vacuum-assisted retention.

| Reduction | Airflow | Suction | Retention | Structural |
|---|---|---|---|---|
| Percentage | Resistance | Force | Efficiency | Deformation |
| (%) | (Relative) | (Relative) | (%) | (%) |
| 10 | Low (*) | High (***) | 85 | 5 |
| 15 | Moderate (**) | Moderate- | 88 | 4.5 |
| | | High (***) | | |
| 20 | Optimal (***) | Optimal | 92 | 4 |
| | | (***) | | |
| 25 | High (****) | Moderate- | 90 | 3.5 |
| | | Low (**) | | |
| 30 | Very High | Low (*) | 85 | 3 |
| | (*****) | | | |

In an embodiment, a reduction in hole diameter between 10% to 30% influences airflow resistance, suction force, retention efficiency, and structural deformation of fiber component (514). At 10% reduction, suction force remains high, but airflow resistance is low, leading to 85% retention efficiency with 5% deformation. At 20% reduction, suction force and airflow resistance reach an optimal balance, affirming 92% retention efficiency with minimal deformation. Increasing reduction to 30% significantly raises airflow resistance but lowers suction force, maintaining 85% retention efficiency with only 3% deformation. Controlled variation in hole diameter optimizes vacuum retention while preventing excessive fiber stress and instability.

In an embodiment, adhesive layer disposed between flexible retention sheet (510) and internal chamber (504) secures flexible retention sheet (510) in place. Said adhesive layer prevents displacement of flexible retention sheet (510) due to variations in negative pressure, enabling consistent vacuum-assisted retention.

In an embodiment, protruded section of flexible retention sheet (510) conforms to engagement recess (506), forming a contoured interfacing arrangement. Said conformance enhances mechanical stability of flexible retention sheet (510), preventing lateral movement during vacuum application. Said configuration optimizes contact between flexible retention sheet (510) and enclosure (502), improving suction force efficiency.

In an embodiment, buffer pad positioned between flexible retention sheet (510) and fiber component (514) comprises alignment openings corresponding to perforation holes (512). Said buffer pad accommodates fiber components (514) with multiple cladding diameters. Presence of alignment openings prevents fiber misalignment, optimizing fiber positioning stability.

In an embodiment, two fiber positioning apparatuses (500) mounted in parallel configuration operate independently to secure fiber components (514) through vacuum-assisted retention. Parallel arrangement enables independent control of fiber component (514) positioning, facilitating multi-fiber alignment experiments. Independent operation of each fiber positioning apparatus (500) prevents cross-interference between fiber components (514), maintaining individual fiber positioning accuracy.

In an embodiment, surfacing layer formed on flexible retention sheet (510) comprises textured structure configured to enhance frictional engagement with fiber component (514). Said textured structure improves mechanical grip on fiber component (514), preventing slippage under vacuum retention. Said surfacing layer stabilizes fiber component (514) positioning, maintaining consistent attachment during vacuum-assisted operation.

In an embodiment, flexible retention sheet (510) is molded with pre-defined fiber grooves to facilitate alignment of fiber component (514). Said pre-defined fiber grooves constrain lateral movement of fiber component (514), enabling axial alignment during vacuum-assisted retention. Integration of pre-defined fiber grooves prevents undesired rotation of fiber component (514), stabilizing fiber positioning.

In an embodiment, adjuster modifies positioning of fiber component (514) relative to flexible retention sheet (510), enabling controlled realignment. Said adjuster provides positional correction capability, assuring accurate placement of fiber component (514) within fiber positioning apparatus (500). Said adjustment mechanism accommodates variations in fiber dimensions, optimizing alignment consistency.

In an embodiment, enclosure (502) comprises internal reinforcement layer extending parallel to internal chamber (504), engaging with engagement recess (506) to enhance structural rigidity. Said internal reinforcement layer prevents deformation of enclosure (502) under vacuum pressure, maintaining stability of fiber positioning apparatus (500). Reinforced enclosure (502) minimizes mechanical deflection, improving long-term durability.

In an embodiment, plurality of vacuum channels (512) arranged in symmetrical alignment structure prevents asymmetrical suction forces that misalign fiber component (514). Said symmetrical alignment structure distributes vacuum pressure evenly across flexible retention sheet (510), enabling uniform attachment force. Prevention of suction imbalance stabilizes fiber component (514) positioning, reducing unintended shifts.

In an embodiment, suction conduit (516) comprises flow-adjusting interface that modulates vacuum suction levels based on positioning of fiber component (514). Said flow-adjusting interface enables dynamic control of suction force, accommodating variations in fiber component (514) diameter. Controlled vacuum adjustment optimizes attachment stability, preventing excessive suction-induced deformation.

In an embodiment, internal chamber (504) comprises pressure-relief section that redirects residual airflow away from vacuum channels (512), preventing vacuum-induced stress. Said pressure-relief section regulates pressure distribution within fiber positioning apparatus (500), reducing structural strain. Controlled airflow redirection stabilizes vacuum application, preventing inconsistencies in fiber retention force.

In an embodiment, engagement recess (506) comprises fiber-positioning guide section that enables controlled lateral positioning of fiber component (514) within flexible retention sheet (510). Said fiber-positioning guide section constrains fiber component (514) movement, maintaining axial alignment. Said configuration prevents unintended displacement of fiber component (514) during vacuum-assisted retention.

In an embodiment, cover positioned over flexible retention sheet (510) regulates airflow across perforation holes (512), maintaining uniform negative pressure distribution for securing fiber component (514). Said cover prevents uncontrolled airflow variations, stabilizing suction force application. Said enclosure enhances vacuum efficiency.

1. A fiber positioning apparatus, comprising:
an enclosure comprising:
an internal chamber;
an engagement recess extending along a portion of the internal chamber; and
an attachment interface positioned on an outer surface of the enclosure;
a flexible retention sheet extending through the internal chamber, wherein the flexible retention sheet comprising a protruded section extending into the engagement recess, wherein the flexible retention sheet comprises a plurality of perforation holes extending there through, wherein the flexible retentions sheet provides an interface to receive at least one fiber component; and
a suction conduit fluidically coupled to the engagement recess and extending along a portion of the enclosure, wherein the suction conduit establishes fluid communication with each perforation hole, wherein the suction conduit is connected to a vacuum source to induce a negative pressure within the flexible retention sheet, wherein the induced negative pressure causes attachment of the each received fiber component to the flexible retention sheet till the induced negative pressure exists.

2. The fiber positioning apparatus of claim 1, wherein the attachment interface is secured to a support structure through a fastening assembly that is positioned along the attachment interface.

3. The fiber positioning apparatus of claim 1, wherein the plurality of perforation holes is confined within the protruded section of the flexible retention sheet.

4. The fiber positioning apparatus of claim 1, wherein the plurality of perforation holes comprises the variable diameters, wherein the variable diameters optimize a suction force distribution for attachment of the fiber components of multiple sizes.

5. The fiber positioning apparatus of claim 1, further comprising a secondary sheet positioned beneath the flexible retention sheet, wherein the secondary sheet comprises a secondary set of holes, each having a diameter smaller than the diameter of the plurality of perforation holes.

6. The fiber positioning apparatus of claim 5, wherein each hole of the secondary set of holes in the secondary sheet has a diameter smaller than the diameter of the plurality of perforation holes by a range of 10% to 30%.

7. The fiber positioning apparatus of claim 1, wherein an adhesive layer is disposed between the flexible retention sheet and the internal chamber, wherein the adhesive layer secures the flexible retention sheet in place to prevent displacement during the variations in induced negative pressure within the suction conduit.

8. The fiber positioning apparatus of claim 1, wherein the protruded section conforms to the engagement recess to establish a contoured interfacing arrangement.

9. The fiber positioning apparatus of claim 1, wherein a buffer pad is positioned between the flexible retention sheet and the fiber component, wherein the buffer pad comprises the alignment openings corresponding to the perforation holes to accommodate the fiber components with multiple cladding diameters.

10. The fiber positioning apparatus of claim 1, wherein two fiber positioning apparatuses are mounted in a parallel configuration, wherein each fiber positioning apparatus operates independently to secure the fiber components through vacuum-assisted retention.

11. The fiber positioning apparatus of claim 1, wherein a surfacing layer is formed on the flexible retention sheet, wherein the surfacing layer comprises a textured structure configured to enhance frictional engagement with each received fiber component.

12. The fiber positioning apparatus of claim 1, wherein the flexible retention sheet is molded with pre-defined fiber grooves, wherein the pre-defined fiber grooves facilitate alignment of each fiber component within the flexible retention sheet.

13. The fiber positioning apparatus of claim 1, further comprising an adjuster configured to modify the positioning of the at least one fiber component relative to the flexible retention sheet.

14. The fiber positioning apparatus of claim 1, wherein the enclosure comprises an internal reinforcement layer extending parallel to the internal chamber, wherein the internal reinforcement layer is engaged with the engagement recess to enhance structural rigidity and prevent deformation under vacuum pressure.

15. The fiber positioning apparatus of claim 1, wherein the plurality of vacuum channels is arranged in a symmetrical alignment structure, wherein the symmetrical alignment structure prevents the asymmetrical suction forces that misaligns the fiber component.

16. The fiber positioning apparatus of claim 1, wherein the suction conduit comprises a flow-adjusting interface, wherein the flow-adjusting interface modulates the vacuum suction levels based on positioning of the fiber component.

17. The fiber positioning apparatus of claim 1, wherein the internal chamber comprises a pressure-relief section, wherein the pressure-relief section prevents a vacuum-induced stress by redirecting residual airflow away from the plurality of vacuum channels.

18. The fiber positioning apparatus of claim 1, wherein the engagement recess comprises a fiber-positioning guide section, wherein the fiber-positioning guide section enables controlled lateral positioning of the fiber component within the flexible retention sheet.

19. The fiber positioning apparatus of claim 1, further comprising a cover positioned over the flexible retention sheet, wherein the cover encloses the flexible retention sheet to regulate airflow across the plurality of perforation holes and maintain uniform negative pressure distribution for securing each received fiber component.

20. A method for securing at least one fiber component within a fiber positioning apparatus, the method comprising:
positioning a flexible retention sheet within an internal chamber of an enclosure, wherein the flexible retention sheet comprises a protruded section extending into an engagement recess of the enclosure and a plurality of perforation holes extending through the flexible retention sheet;
receiving the at least one fiber component on the flexible retention sheet such that the at least one fiber component aligns with at least one of the plurality of perforation holes;
activating a vacuum source connected to a suction conduit fluidically coupled to the engagement recess, wherein the suction conduit establishes fluid communication with each perforation hole;
inducing a negative pressure within the flexible retention sheet via the suction conduit, wherein the negative pressure is transmitted through the plurality of perforation holes to generate a vacuum retention force for securing the at least one fiber component against the flexible retention sheet;
maintaining the attachment of the at least one fiber component to the flexible retention sheet if the induced negative pressure exists; and
releasing the at least one fiber component by deactivating the vacuum source, thereby eliminating the negative pressure within the flexible retention sheet.
